(19) United States
(12) Patent Application Publication
(10) Pub. No.: US 2011/0228918 A1
(43) Pub. Date: Sep. 22, 2011

(54) REAL-TIME MEDIA BROADCASTING VIA TELEPHONE

(76) Inventors: Andy Mark Ayers, Kingsley (GB); Mark Kingsley Smith, Haynes (GB)

(21) Appl. No.: 13/126,305

(22) PCT Filed: Nov. 13, 2009
(86) PCT No.: PCT/GB09/51533

§ 371 Date: May 24, 2011

Related U.S. Application Data
(60) Provisional application No. 61/150,184, filed on Feb. 5, 2009.

(30) Foreign Application Priority Data
Nov. 14, 2008 (GB) 0820862.1

(51) Int. Cl. H04M 11/00; H04M 11/10

(52) U.S. Cl. 379/88.17; 379/90.01

(57) ABSTRACT

Disclosed are systems and methods for live broadcasting of one or more media streams, such as audio streams, via the internet such that it is accessible substantially by a number of listeners at a number of locations. Said system is operable such that the contents of each of said one or more media streams can originate from a call or other communication from a conventional telephony device which does not require internet connection.

This invention is in the general field of broadcasting, and in particular, but not limited to, live broadcasting over the internet.

The live broadcasting of events, such as sporting events or shows, has become increasingly popular in recent times. However, this tends to be limited to the more popular and larger events and sports. For many less popular sports, smaller events or amateur teams, live coverage is not feasible, due to the relatively small numbers likely to listen or watch. However, these relatively small numbers of listeners would appreciate the opportunity to listen or watch their favourite sports, events or teams.

The relatively recent development of internet radio has made it considerably easier to broadcast your own radio programmes to many listeners. Relatively low priced computer equipment, software and a streaming media server is all that is required to start your own radio station from your own home.

A main drawback with this, however, is the portability and convenience of the equipment required for broadcasting. It may be that you wish to broadcast remotely, for example to provide live coverage of an event. At the very least, you would be required to bring computer equipment, such as a laptop, microphone, headphones all set up specifically with the correct software. And even then, broadcast would only be possible if there was wi-fi coverage or a fixed line that you could plug your computer into.

For a traditional radio broadcast live from an event there are various resources required:
Human resources—commentators, producers and engineers;
Portable equipment—such as an audio mixing desk with microphone input and ISDN output, headphone and microphones;
Connectivity—permanent or temporary ISDN lines.

The typical approach is as follows:

The commentary team will be provided with a location with clear views of the playing area, each commentator (there may be more than one), will have headphone and a microphone which will be connected to a portable mixing desk. This mixing desk is connected to either a permanent ISDN line (a major broadcaster may have their own permanent ISDN lines installed in some or all major sporting venues) or a temporary ISDN line would have to be installed by a telecoms provider. Depending on the complexity of the commentary a producer and a sound engineer will also be present. As a result, such a broadcast can be very expensive. The table below provides an estimate of expected costs that may be incurred in such a broadcast.

| Costs | |
|---|---|
| Commentator | £250 per day |
| Mixing desk | £1440 per unit |
| Headphones | £95.85 |
| Microphone | £94.05 |
| ISDN line permanent # | £200 install and |
| | £90.78 per quarter |
| ISDN line temporary # | £200 install |
| Producer | £200 per day |
| Sound Engineer | £200 per day |
| Cost per day (assume 2 | £2919.80 (inc mixing |
| commentators, temporary | desk, 2 × mics and |
| ISDN, one producer and | 2 × headphones) |
| one sound engineer) | |

It is an aim of the present invention to address these issues and other situations where cheap and simple live broadcasting is desirable.

In a first aspect of the invention there is provided a system for live broadcasting of one or more media (e.g. audio and/or video) streams via the internet such that it is accessible substantially by one or more of listeners/viewers at one or more locations, wherein said system is operable such that the contents of each of said one or more media streams can originate from a call or other communication from a conventional fixed or mobile telephone or similar device which does not require internet connection.

Said system may comprise a call handling server, which may be implemented as a software telephone switch, connected to at least one telephone line (directly, or indirectly across the internet via a voip telephony provider), and a media streaming server for streaming the contents of incoming calls over the internet. Said media streaming server may be configured to automatically handle new incoming streams as they arrive.

Said system may further comprise an internet site whereon some or all of the streams can be accessed. Said system may also be arranged, alternatively or additionally, to broadcast the stream to an internet site of a caller's choosing.

Said system is preferably arranged to be operable to handle a plurality of incoming calls simultaneously, so as to simultaneously broadcast their content.

Said system may specifically be adapted for the broadcasting of audio streams. Said system may be specifically adapted to provide a medium for internet radio broadcasting from fixed or mobile telephone or similar device.

Said fixed or mobile telephone or similar device may be any such device, on any type of network and according to any standard or “generation”. In particular, access is not limited to “3G, or third generation” or later handsets, and does not require any specific network capabilities other than that required for normal conversation. Neither does the handset require any specialist software, plug-ins or functionality, other than that required for normal conversation.

Said system may be arranged to present a caller with a user interface, for example voice or keypad operated, to enable them to access their account details and/or set up a live session, and therefore to begin live broadcasting of their call without human intervention. Alternatively, each user account will be issued with a unique telephone number for access to the system.

Said system may also include means for recording the streams, for later playback.

As an alternative to live broadcast, said system may present a caller with the opportunity to choose to have his call recorded, and to present the caller with the option to hear said call and amend it prior to broadcast.

Any reference to call or caller in the above paragraphs is equally applicable to the transmission of a video stream from a conventional or (as is more likely) mobile telephone or similar device, and its initiator/sender.

Said system may be configured to inform a caller, for example verbally or via text message, of the address or url people should visit to listen to their broadcasts.

Said system may also be operable to broadcast streams from a computer equipped with the relevant audio and/or video input devices and/or to broadcast uploaded content pre-recorded elsewhere.

Said system may enable two-way communication, and therefore route messages or streams back to a caller device. Said caller device may be the same device being used to originate the data streams.

In a further aspect of the invention there is provided a method of broadcasting media live over the internet from a conventional telephony device, comprising the steps of:
having a caller call a telephone number from said conventional telephony device thereby placing a call via a telephone network, without using the internet;
answering said call and processing its content into a data stream; and
broadcasting, live, said data stream over the internet.

Said method may further include the step of recording said data stream.

Said broadcasting of said data stream may be effected by broadcasting on a dedicated internet site. Alternatively, or in addition, said data stream may be broadcast on a site of said caller's choosing.

Said method may include the answering of a plurality of calls and broadcasting of a plurality of data streams simultaneously.

Said method may specifically comprise the broadcasting of audio streams only so as to allow the caller to implement an internet radio programme via said fixed or mobile telephone or similar device.

### BRIEF DESCRIPTION OF THE DRAWINGS

Embodiments of the invention will now be described, by way of example only, by reference to the accompanying drawings, in which:

FIG. 1 shows a system according to an embodiment of the invention.

### DETAILED DESCRIPTION OF THE EMBODIMENTS

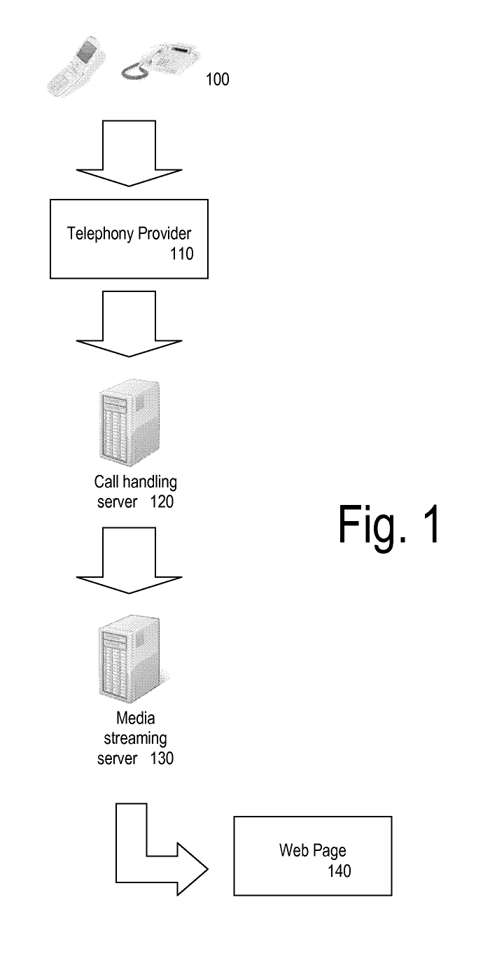

FIG. 1 shows a basic overview of the system according to an embodiment of the invention. The system is comprised of three main elements, a call handling server 120, a media streaming server 130, and a web page 140, arranged such that the call handling server 110 is attached to a telephone line (directly or indirectly via a viop provider) and therefore can receive calls from a telephony provider 110.

In use, a person with a telephone 100, which can be a fixed or mobile (cell) phone, can telephone a predetermined number in the same way as if they were making a conventional telephone call. The call is routed across the internet by the telephony provider 110, based on the number dialed, to a call handling server 120.

The call handling server 110 could be implemented using any telephone switch software. In this system it is connected to one or more phone lines and essentially acts as a connection to the VOIP (voice over internet protocol) gateway. The switch 110 answers the telephone call from telephone 100, as well as other telephone calls from other callers, and processes the audio/video data into streams which it then forwards on, essentially as a one sided telephone conversation. In one embodiment, the call handling server 110 may, on answering an incoming call, present the caller with a control interface via their telephone interface. This may allow the caller access to their particular account etc. The caller may also be provided with advertisements or jingles.

In a main embodiment, the installation also involves a number of scripts able to record various parameters to a database These parameter may include time of call, duration, caller identification, number of live listeners, time the call ended, account identification, call status (whether live or not live), and/or a filename for saving. It is also possible that some additional information could be provided verbally by the caller which then gets translated using a speech to text engine into textual data which is also stored in the database.

Furthermore, as an alternative to live broadcasting, said telephone handling server 110 may, at the caller's request, record the message instead of just broadcasting live. This message could then be reviewed and amended by the caller as required, before being forwarded for broadcast.

The media server 120 again may be based upon known media streaming software, although they have been modified to enable live sessions to be created on the fly rather than via configuration files. Each stream may then be published to a web page on the internet, such that a user accessing said web page can select any one of the streams. The web page may involve a range of asp, php and asp.net scripts combined with a Flash (rtm) movie (or similar add-in) to create an attractive front end.

The media server preferably should be arranged to automatically open up broadcast channels (or mount points) for each incoming stream as they are passed over from the call handling server. In this way, no intervention is required for the system to handle any number of incoming telephone calls at one time.

In this way, a radio broadcast can be made simply by using a telephone, with no other equipment being required. A caller/presenter can simply dial the number for the service, prompting the telephony provider to route the call to the call handling server 110. The caller then can begin to broadcast, for example to commentate on a sporting event, either because it has not gained any other coverage, or to provide an alternative (amateur) coverage. In this way, broadcasting of an event may be done simply be talking into a conventional (fixed or mobile) telephone, without the need for computing facilities, internet access, etc

The costs incurred for providing a radio broadcast in this way, compares very favourably to the costs incurred for traditional broadcasting mentioned in the introduction. In fact, the only costs incurred from that table would be the optional cost of a commentator, with the additional costs of a telephone call and modest system service fee.

As many telephone devices, and in particular mobile telephone handsets, are able to capture video images, it is also within the scope of the invention for the system to broadcast video, as well as audio.

The call handling server 110 essentially acts as an exchange, handling this call and other calls simultaneously. The audio, or possibly video stream is captured from each call received and is forwarded as an appropriately encoded data stream to the media streaming server 120. Ideally, the data stream will also be captured and recorded by the call handling server.

The media streaming server 120 handles each stream from each caller, received from the call handing server 110. Each stream can then be presented to one or more listeners via a website. The website may be a single website, forming part of the system, in which users can “tune into”, that is select, streams of their choice, as with conventional radio. Alternatively, or in addition, a specific stream may be accessed through a specific website, such as a website associated with the caller/broadcaster.

The entire system should be operable such that the streams are/can be broadcast essentially live (allowing for normal system delays etc.). This allows for the live broadcasting of events from the event location, without the presenter/commentator needing anything other than a telephone to make the broadcast. Interested listeners (or viewers) can then simply choose the appropriate stream from the system website, and listen to (or watch) the event, live, from anywhere in the world. The system's website could then become a hub for minority event broadcasting, particularly live event broadcasting. The broadcasts could be grouped according to the number that the broadcast was made from, the number that was dialed in to, a unique pin code entered at the start of the call via the telephone keypad or a combination of the above.

The system may be arranged to archive the streams, either as an alternative to broadcasting live, should you wish to broadcast later, or take advantage of the systems for other applications as mentioned later, or as well as broadcasting live, to allow listeners/viewers to listen to or watch events again, and/or to enable highlights packages to be made etc. These saved clips could be grouped together with subsequent live feeds to form the equivalent of a multi-media blog or an audio visual diary.

Being internet based, two-way communication is also possible. In particular, the system may allow for questions or observations to be inputted by listeners/viewers, both during broadcast and afterwards. The system may then route the questions/observations to the presenter via text or e-mail to his telephone (or to any other device he may have) for immediate answer/comment, or otherwise be archived to be dealt with at another time.

The phone number called to begin broadcasting may be unique to that caller/institution, each telephone number being linked to a particular user account. Depending on account set-up, incoming broadcasts from that number may be streamed live on the internet and stored in a multi-media blog linked to that number. In one embodiment the caller will be informed either verbally or via text message of the address or url people should visit to listen to their broadcasts or view the associated blog. The supporting website, following an authentication process to verify ownership of that number, would allow the broadcaster to configure, customise and share their broadcasts with others.

While the above has been described with the application of live broadcasting of events foremost, it should be noted that this system has many other applications. These may include:
Allowing certain organisations, having numbers that are not large enough to attract sponsorship for what conventionally is an expensive undertaking, a means of running their own radio stations with programmes based around certain channels. So, say every Tuesday at 5 pm is ‘Coaching Hour’, or Monday at 7 pm is ‘Question Time’ with the Senior Management Team etc
A more formal version of the personal audio video diary. Any project wanting to share progress or issue updates to stakeholders and interested parties could use this technology to broadcast and collate hourly, daily, weekly,
Monthly reports for all to view via the internet.
Blogging. One particular blogging application is to make blogging more accessible for the visually impaired and learning difficulties—at the moment blogging is primarily a text based information service. The multi-media nature of these feeds (audio only in the case of visual impairment), and the fact that the posting process doesn't require the use of a computer at all, makes it much more engaging for the visually impaired and for users with learning difficulties. Furthermore, blogging in general can be transformed. At the moment blogging is fairly low-tech, and about as sophisticated as someone sitting in front of a PC typing out their thoughts, editing them a bit and pasting them on website. Some time later, other people will visit that website, read the thoughts, at which point the whole process starts again. It's actually not much more than an accelerated version of Gutenberg's press. Instead, the system described herein can allow for instant real-time blogging.
Support desk: A company could obtain their own number, customise the welcome message and have all calls to that number automatically recorded, stored and accessible via the internet as the basis for a support/help desk.
Audio listings: To allow clubs, institutions and Local Authorities to ring in their activities for the following week(s) or month(s), which is then auto posted to their clubs entry on the relevant website in real time.
Within social networking applications, the ability for an individual or group to broadcast live an activity they were undertaking or about to undertake

In addition to the core functionality outlined above it should also be possible to broadcast using a computer equipped with the relevant audio video input devices and to upload audio and video clips pre-recorded elsewhere.

The above embodiments are for illustration only and other embodiments and variations are possible and envisaged without departing from the spirit and scope of the invention.

1. A system for live broadcasting of one or more media streams via the Internet such that it is accessible substantially by one or more of recipients at one or more locations comprising:
a call handling server for receiving a conventional telephone call and a media streaming server for streaming the contents of said call over the Internet, said call handling server having functionality to handle conventional telephone calls received via conventional fixed and mobile telephone networks; and
wherein contents of each of said one or more media streams can originate from said conventional telephone call sent from a conventional telephony device which does not require Internet connection or specialist software.

2. A system as claimed in claim 1, wherein said call handling server is implemented as a software telephone switch connected to at least one telephone line.

3. A system as claimed in claim 1, wherein said media streaming server is configured to automatically handle new incoming streams as they arrive.

4. A system as claimed in claim 1, comprising an Internet site on which some or all of the streams can be accessed.

5. A system as claimed in claim 1, wherein the system handles a plurality of incoming calls simultaneously so as to simultaneously broadcast their content.

6. A system as claimed in claim 1, specifically adapted for the broadcasting of audio streams.

7. A system as claimed in claim 1, comprising means for recording the streams.

8. A system as claimed in claim 7, wherein, as an alternative to live broadcast, said system presents a caller with the opportunity to choose to have his call recorded and to present the caller with the option to hear said call and amend it prior to broadcast.

9. A system as claimed in claim 1, specifically adapted to provide a medium for Internet radio broadcasting from fixed or mobile telephone or similar device.

10. A system as claimed in claim 1, wherein the system is arranged to present a caller with a user interface to enable them to access their account details and/or set up a live session and begin live broadcasting of their call without human intervention.

11. A system as claimed in claim 10, wherein each user account is issued with a unique telephone number for access to the system.

12. A system as claimed in claim 1, wherein the system is configured to inform a caller of the website address or Uniform Resource Locator (URL) people should visit to listen to their broadcasts.

13. A system as claimed in claim 1, wherein the system broadcasts streams received from a computer equipped with the relevant audio and/or video input devices and/or to broadcast uploaded content pre-recorded elsewhere.

14. A system as claimed in claim 1, wherein the system enables two-way communication.

15. A system as claimed in claim 1, wherein said telephony device comprises a fixed or mobile telephone.

16. A system as claimed in claim 1, wherein the system is arranged, alternatively or additionally, to broadcast the stream to an Internet site of a caller's choosing.

17. A method of broadcasting media live over the Internet from a conventional telephony device having no specialist software, comprising the steps of:
having a caller call a telephone number from said conventional telephony device thereby placing a call via a conventional mobile or fixed telephone network, without using the Internet;
answering said call and processing its content into a data stream; and
broadcasting, live, said data stream over the Internet.

18. A method as claimed in claim 17, further comprising the step of recording said data stream.

19. A method as claimed in claim 17, wherein said broadcasting of said data stream is effected by broadcasting on a dedicated Internet site.

20. A method as claimed in claim 17, wherein said data stream is broadcast on a site of said caller's choosing.

21. A method as claimed in claim 17, further including the answering of a plurality of calls and broadcasting of a plurality of data streams simultaneously.

22. A method as claimed in claim 17, comprising the broadcasting of audio streams only so as to allow the caller to implement an Internet radio programme via said conventional telephony device.

23. A method as claimed in claim 17, wherein said conventional telephony device comprises a fixed or mobile telephone.
